(19) United States
(12) Patent Application Publication
(10) Pub. No.: US 2004/0169885 A1
(43) Pub. Date: Sep. 2, 2004

(54) Memory management

(76) Inventors: Douglas J. Mellor, Meridian, ID (US); Justen R. Meltz, Boise, ID (US); Perry Lea, Meridian, ID (US)

Correspondence Address: HEWLETT-PACKARD COMPANY, Intellectual Property Administration, P.O. Box 272400, Fort Collins, CO, 80527-2400, US

(21) Appl. No.: 10/378,128

(22) Filed: Feb. 28, 2003

(51) Int. Cl. G06F 12/00; G06F 3/12; G06F 11/30

(52) U.S. Cl. 358/1.16; 358/404; 718/104

(57) ABSTRACT

Memory management. A method embodiment includes receiving data separable into segments. For each segment, it is determined whether to save that segment to a first memory such as RAM or to a second memory such as a hard disk. Each segment is saved to a determined location. While saving each segment determined to be saved to the first memory, it is determined whether the first memory is depleted. When the first memory is determined to be depleted, a segment being saved to the first memory is instead saved to the second memory.

### BACKGROUND

This invention relates to managing memory. More particularly, the invention is directed to managing the manner in which print job data is stored in the memory of an image forming device such as a laser printer.

There are several ways to store print job data in an image forming device. Many image forming devices use a hard disk drive in combination with random access memory (RAM). The RAM is used to store the print job data or segments of the print job data as the data is fed to a print engine. The hard disk is used to store more voluminous print job data and to prevent the RAM from becoming over burdened.

When a single copy of a print job is to be printed, data representing each page or segment thereof is temporarily stored in a section of RAM and printed. Once that page or segment is printed, the section of RAM is released and can be used to store a subsequent page or segment to be printed. Often, users desire to print multiple collated copies of a single print job. In these cases, data for each page or segment is stored to a section of memory. The sections of memory used to store the print job data are not released until all copies are printed.

In a typical image forming device, a hard disk has a far greater memory capacity than RAM. For example, a hard disk may be capable of storing twenty or more gigabytes of data where RAM is often limited to one to two hundred megabytes. So, when printing multiple collated copies of a relatively large print job, there is often insufficient RAM to store all print job data and a hard disk must be utilized. Data, however, can be retrieved and processed from RAM much more quickly than from a hard disk. To more efficiently print each copy, the print job data should be stored, to the extent possible, in RAM. Once the RAM is filled, the remaining data should then be stored on the hard disk.

### DESCRIPTION OF THE DRAWINGS

FIG. 1 is a schematic representation of a computing environment in which embodiments of the present invention may be incorporated.

FIG. 2 illustrates a printed document and multiple collated copies of that document.

FIG. 3 is a block diagram illustrating components of an image forming device according to an embodiment of the present invention.

FIG. 4 is a block diagram illustrating components of a guarantee module according to an embodiment of the present invention.

FIG. 5 is a block diagram showing print job data stored in RAM and on a disk according to an embodiment of the present invention.

FIG. 6 is a block diagram showing the contents of metadata according to an embodiment of the present invention.

FIG. 7 illustrates a page broken into strips.

FIG. 8 is a chart illustrating print job data being processed over time.

FIG. 9 is a flow diagram illustrating steps taken to store and print multiple collated copies of a print job according to an embodiment of the present invention.

FIG. 10 is a flow diagram further illustrating the determining and processing steps of FIG. 9 according to an embodiment of the present invention.

### DETAILED DESCRIPTION OF THE INVENTION

INTRODUCTION: Image forming devices such as printers and copiers are often called upon to print multiple collated copies of a print job. These devices often include volatile high speed memory such as RAM and lower speed non-volatile memory such as a hard disk. When processing a print job, all available high speed memory is used to store print job data. Once the RAM is filled, the remaining print job data is stored to a hard disk. The present invention involves both proactively and reactively determining when to stop storing print job data in RAM and start storing print job data to a hard disk.

By default, print job data is stored to RAM. A reactive approach involves detecting when the available RAM is depleted and then reacting by saving the print job to disk and freeing any needed RAM. Proactive approaches involve predicting when the available RAM will be depleted and then attempting to prevent the available RAM from being depleted. Examples of proactive approaches include monitoring available RAM as well as noting where prior data for the current print job was stored. If the available RAM is less than a critical value or if prior print job data was stored to disk, then the current print job data will be stored to disk.

In the sections to follow, embodiments of the present invention are described with reference to printing. It is noted that the present invention is not limited to printing, but can be incorporated into any system or method that uses two or more memory locations to store data.

Commonly assigned, co-pending, application Ser. No. 10/136918, filed Apr. 30, 2002, and entitled: “System and Method for Managing Storage of Data in Printing Devices,” discusses methods for storing print job data in RAM. That application is incorporated by reference in its entirety.

The following description is broken into sections. The first section describes an environment in which embodiments of the present invention may be implemented. The second section describes the physical and logical components of an image forming device that are used to implement embodiments of the present invention. The third section describes steps taken to practice embodiments of the present invention.

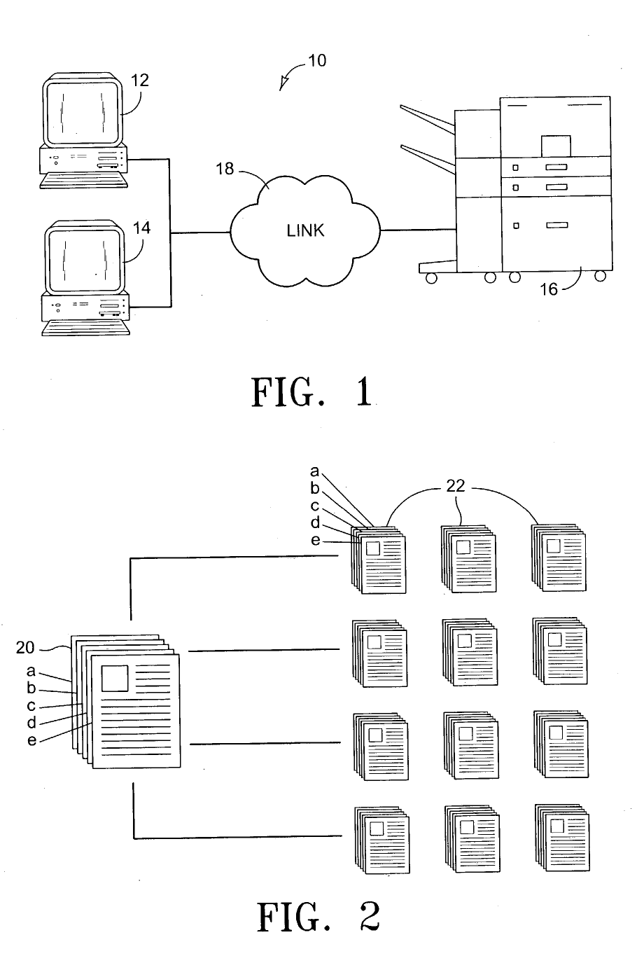

ENVIRONMENT: FIG. 1 illustrates a printing environment 10 in which it would be advantageous to implement embodiments of the present invention. Environment 10 includes computers 12 and 14 and image forming device 16. Computers 12 and 14 represent generally any computing device such as a desktop computer, laptop computer, or PDA (Personal Digital Assistant) that may send a print job to image forming device 16. Image forming device 16 represents generally any combination of hardware and programming capable of processing a print job and producing an image such as text and graphics on a media sheet such as paper or transparency. Examples include printers, copiers, and facsimile machines as well as multi-function devices that provide all three functions. It is noted that that where an image forming device functions as a copier, it can create a print job without the need for computers 12 and 14.

Computers 12 and 14 and image forming device 16 are interconnected by link 18. Link 18 represents generally a cable, wireless, or remote connection via a telecommunication link, an infrared link, a radio frequency link, and/or any other connector or system that provides electronic communication between devices 12-16. Link 18 may represent an intranet, the Internet, or a combination of both.

The term print job refers to a series of instructions directing image forming device 16 to produce images on one or more media sheets. The instructions may include directions to form text, graphics, or a combination of both. A print job may be generated by computer 12 or 14 or directly from image forming device 16 where image forming device functions as a copier. The instructions may also include finishing directions such as direction to print multiple collated copies. A print job is separable into segments. A segment may be a page or a discrete section or strip of a page.

Referring now to FIG. 2, when acting on a print job for multiple collated copies, image forming device 16 concurrently processes the print job and prints the first copy 20. First copy 20 includes pages a through e. The processed print job is referred to as print job data. When processing the print job, image forming device 16 stores print job data representing the print job in memory. Once pages a through e of first copy 20 are printed, image forming device 16 retrieves the print job data for pages a through e as needed and sequentially prints and collates subsequent copies 22.

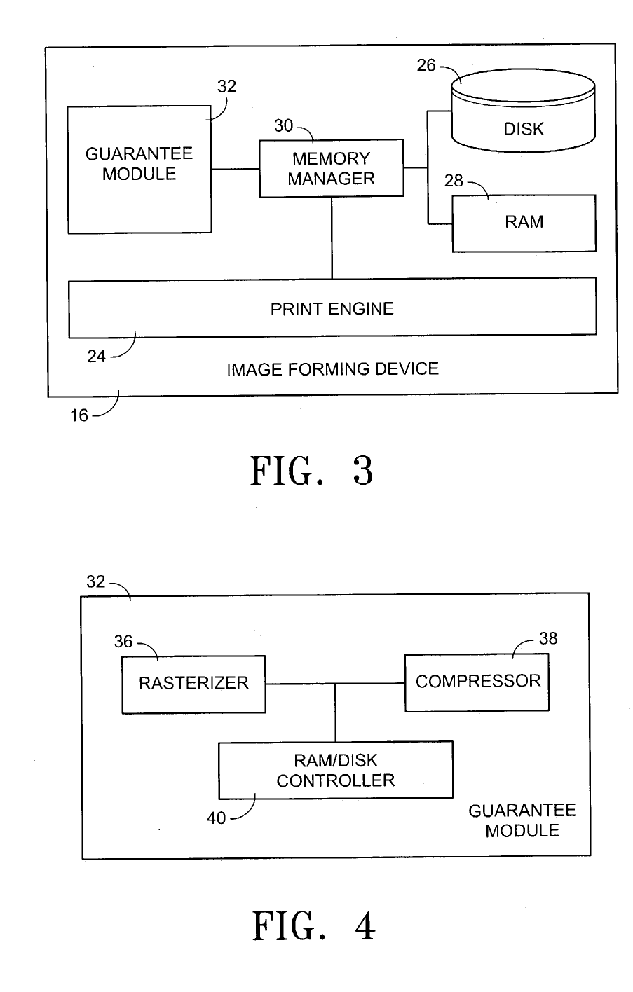

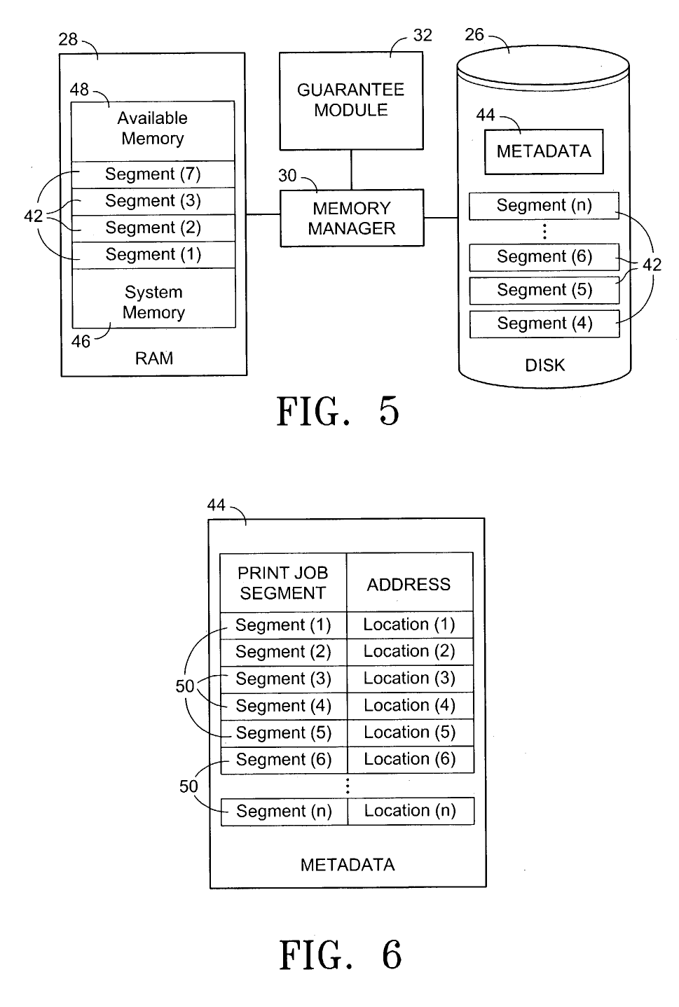

COMPONENTS: The logical components of one embodiment of the invention will now be described with reference to the block diagrams of FIGS. 3 and 4. FIGS. 5-8 will help to illustrate the functions of the components illustrated in FIGS. 3 and 4. Beginning with FIG. 3, image forming device 16 includes, among other components not shown, print engine 24, disk 26, RAM (Random Access Memory) 28, memory manager 30, and guarantee module 32.

Print engine 24 represents hardware and programming capable of utilizing print job data to print images on media sheets. Where, for example, image forming device 16 is a laser printer, print engine 24 includes an optical scanner, a photo conducting drum, toner and a fuser. Using print job data, the optical scanner modulates a laser beam across the drum. The scanned portions of the drum attract toner. Toner is transferred from the drum to a media sheet forming the desired image. The fuser makes the toner transfer permanent.

Disk 26 represents generally any non-volatile memory. RAM 28 represents generally any random access memory. Memory manager 30 represents any programming capable of reading from and writing data to disk 26 and RAM 28. Memory manager 30 is also responsible for monitoring properties of disk 26 and RAM 28. For example, memory manager 30 is capable of identifying the amount of available memory in RAM 28 and on disk 26.

Guarantee module 32 represents programming capable of processing a print job and directing memory manager 30 to store print job data in RAM 28 and on disk 26. When received by image forming device 16, a print job is typically in PDL (Page Description Language) format. The PDL format describes the layout and contents of a printed page or pages. Modern versions of the PDL format are object-oriented, meaning that they describe a page in terms of geometrical objects such as lines, arcs, and circles. Guarantee module 32 is responsible for converting a print job into data, referred to as print job data, which can be used by print engine 24. Where image forming device 16 is or includes a laser printer, processing typically includes rendering the print job into a binary stream of data that defines the location and properties of each pixel to be printed.

Referring now to FIG. 4, guarantee module 32 includes rasterizer 36, compressor 38, and controller 40. Rasterizer 36 represents generally any programming capable of rendering a print job into a binary stream of print job data that defines the location and properties of each pixel to be printed by print engine 24. A binary data stream that defines the location and properties of each pixel is relatively quite large and would quickly deplete RAM 28. Compressor 38 represents programming capable of compressing the data stream into a more manageable size. Controller 40 represents programming capable of (1) identifying the available memory in RAM 28, (2) determining whether to store print job data in RAM 28 or on disk 26; and (3) directing memory manager 30 to store print job data accordingly.

When processing a print job into print job data, guarantee module 32 breaks the print job data into smaller segments and directs memory manager 30 to save each segment in RAM 28 and/or on disk 26. Each segment, for example, may be a page or smaller portion of the print job.

FIG. 5 illustrates print job data stored in RAM 28 and on disk 26. The print job data is broken into segments 42. Each segment 42, in this example, represents a page to be printed. Segments 42 containing data for printing some pages are stored in RAM 28 and others are stored on disk 26. Each segment 42 is identified by an address that specifies the segment's position in RAM 28 or on disk 26. Portions of RAM 28 not filled by segments 42 are referred to as system memory 46 and available memory 48. System memory 46 is used by other components of image forming device 16 and is not available for processing print jobs. Available memory 48 represents the memory available to process a current print job. When processing the print job, guarantee module 32 stores data identifying each segment 42 and the address of each segment as metadata 44 on disk 26.

FIG. 6 illustrates an example of metadata 44. In this example metadata 44 is a table of entries 50. Each entry 50 represents a segment 42 in RAM 28 or on disk 26. A given entry 50 contains data identifying the segment as well as the address of the segment 42 it represents. The order in which the segment 42 is to be printed is reflected by the position of the entry 50 representing that segment 42 in metadata 44.

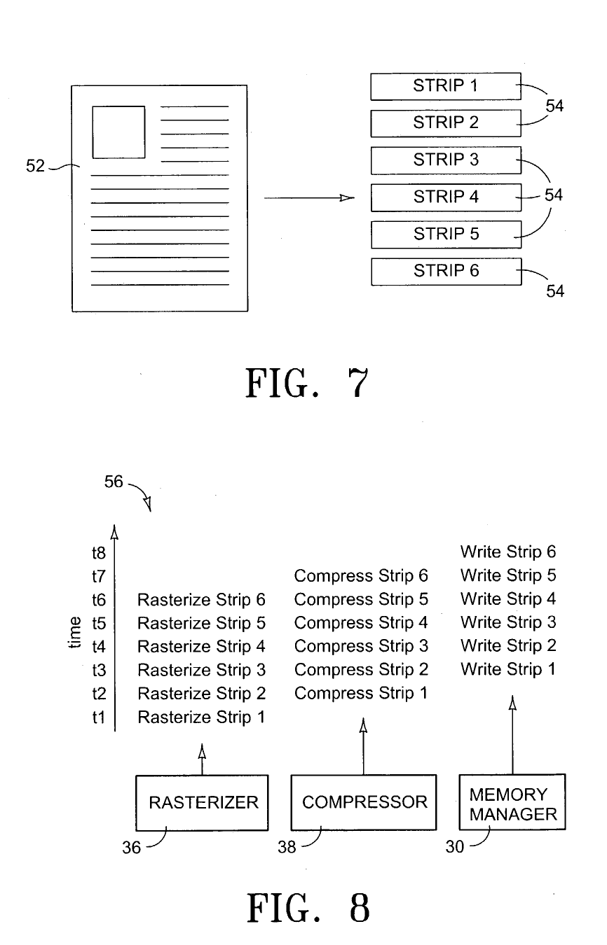

Referring now to FIG. 7, guarantee module 32 processes each page 52 of a print job in strips 54. Strips 52 each represent a coherent segment of a page. In the example of FIG. 7, printing strips 54 in the order indicated would create page 52. When processing page 52, strips 54 are concurrently rasterized, compressed, and written to RAM 28.

FIG. 8 helps to illustrate the processing of page 52 over time. The illustrated timeline is broken into time periods—t1 through t8. At t1, strip one is rasterized. At t2, strip two is rasterized and strip one is compressed. At t3, strip three is rasterized, strip two is compressed, and strip one is written to RAM 28. The process continues until strip 6 is written to RAM 28 at t8.

It is noted that FIG. 8 presumes that equal amounts of time are required to rasterize, compress, and write a strip. This is not necessarily the case. Depending upon the complexity of a given strip is may take more or less time to compress than to rasterize. Where it takes longer to compress, more than one strip may be rasterized during the same time period that a previously rasterized strip is being compressed. Later in the process, it may take longer the rasterize than compress. More than one rasterized strip may then be compressed during the same time period that a subsequent strip is being rasterized.

Once each strip 54 of a page is written to RAM 28, guarantee module 32 determines whether to keep the strips 54 as a segment 42 in RAM 28 or transfer the strips 54 to form a segment 42 on disk 26. Once that decision is made and the new segment 42 is added to RAM 28 or disk 26, guarantee module 32 adds to metadata 44 a new entry 50 representing the new segment 42.

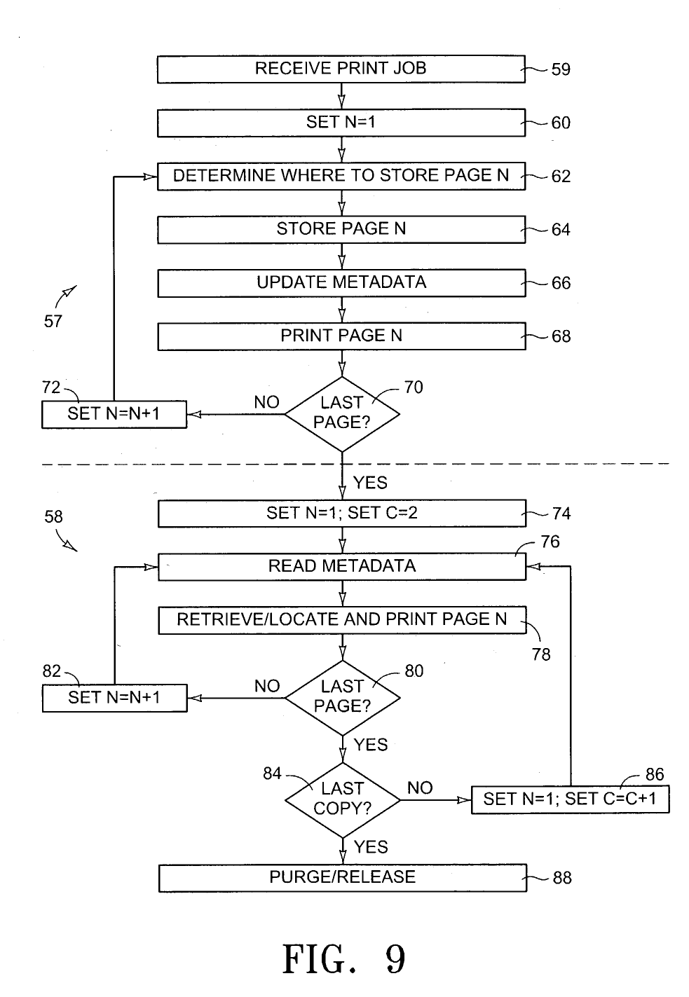

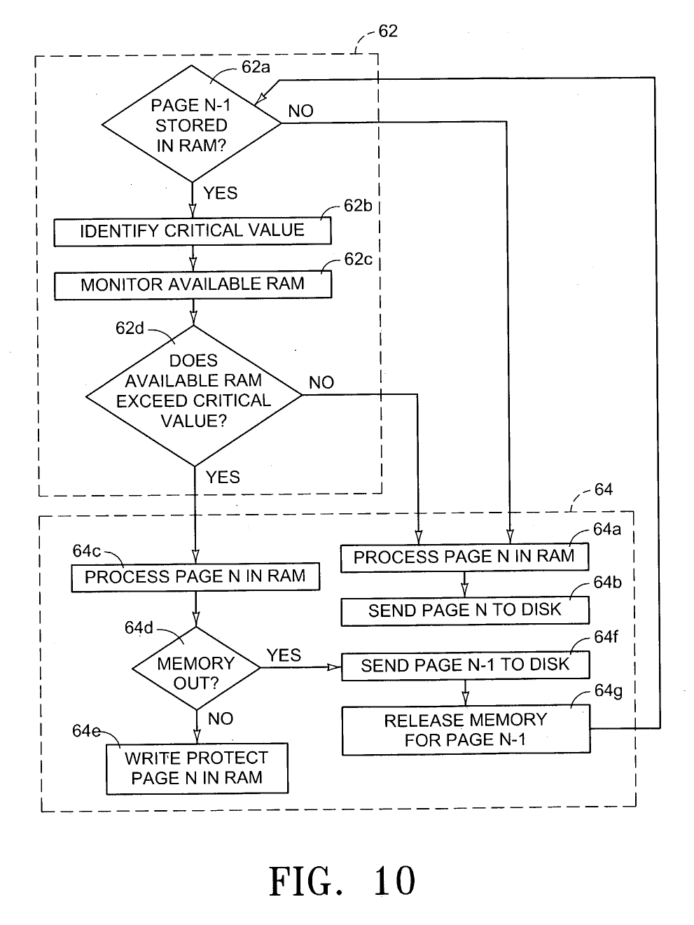

OPERATION: The operation of one embodiment of the present invention will now be described with reference to the flow diagrams of FIGS. 9 and 10. FIG. 9 illustrates steps taken to process and print a print job requiring multiple collated copies. FIG. 9 is broken into two sections 57 and 58. Section 57 includes steps 59-72 for processing the print job data and printing the first copy. Section 58 includes steps 74-88 for printing the remaining copies.

Starting with section 57, a print job requiring multiple collated copies is received (step 59) and a counter with variable N is set to one (step 60). The value of variable N reflects the current page of the print job. Alternatively, print job data could be broken into strips 54, and the variable N could represent the current strip 54. Controller 40 determines whether to store print job data for page N in RAM 28 or on disk 26 (step 62) and then stores page N (step 64). Controller 40 updates metadata 44 to include a reference for page N (step 66). Page N is printed (step 68). It is then determined whether page N is the last page of the print job (step 70). If not, the variable N is incremented (step 72) and the method continues with step 62.

Moving to section 58, if page N is the last page of the print job, the variable N is reset to one and a new counter with the variable C is set to two (step 74). The variable C represents the number of copies that have or are in the process of being printed. The first copy was printed during steps 62-72. The remaining copies starting with copy two are printed during the following steps. Controller 40 reads metadata 44 to identify page N (step 76). Page N is then retrieved from disk 26 or located in RAM 28 and printed (step 78). It is then determined whether page N is the last page of copy C (step 80). If not, the variable N is incremented (step 82) and the method repeats with step 76.

If the answer is yes to the question posed in step 80, it is then determined whether the last copy of the print job has been printed (step 84). If the answer is no, the variable C is incremented and the variable N is reset to one (step 86), and the method repeats with step 76. If the answer is yes, the print job is complete and the memory used to store print job data is purged or released (step 88).

Referring now to FIG. 10, steps 62 and 64 are shown in more detail. It is first ascertained whether print job data for the previous page of the current print job, page N−1, was written to RAM 28 (step 62a). If the answer is no, the method continues with step 64a, as described below. If the answer is yes, controller 40 identifies a critical value (step 62b). The critical value represents an amount of memory in RAM 28 predicted to be sufficient to store print data for page N in RAM 28. Because print job data for page N has yet to be saved to RAM 28, page N is not known how much memory will be required.

The critical value can be calculated in a number of manners. The critical value for an image forming device may be calculated or set at the factory. Manufacturer testing may be conducted to determine an average amount of memory required to store a page of print data. The critical value may be equated with that amount. Or, to create a buffer, the average may be increased by a set percentage, and the critical value may be equated with that increased average.

The critical value may be set by the manufacturer in another manner. It may be equated with the largest amount of memory required to store a page of print data. Before it is compressed, rasterized print job data for a given page requires the same amount of memory as the rasterized but uncompressed print job data for any other page. Depending upon the nature of a given page, rasterized data for that page can be compressed by a given percentage. For example, a segment that contains primarily text can be compressed more than a segment that contains primarily graphics. Rasterized print job data for a scanned photo can be compressed very little. To ensure that the memory required to store print job data will never exceed the critical value, the critical value can be equated with the amount of memory required to store rasterized but uncompressed print job data for a page. Because some level of compression is almost always possible, that value may be decreased by a given percentage.

Instead of being set by the manufacturer, a critical value may be calculated based upon historical use of an image forming device in the customer's environment. This allows the critical value to be optimized based upon the printing habits of a user or group of users. A critical value may be the largest amount of memory required so far to store a page of the current print job in RAM 28. It may be calculated by identifying the largest amount of memory required to store a page of an identified number of previous pages. Because the largest value is not necessarily an appropriate critical value, the identified largest amount of memory may then be decreased by a relatively small percentage.

The critical value may instead be an average amount of memory required to store a page. That average may be calculated by monitoring the amount of memory required to store the previous pages of the print job (in RAM 28 and to disk 26) or a set number of previous pages spanning two or more print jobs. To create a buffer, the average may be artificially increased by a relatively small percentage so that it is greater than the actual average but less than the largest amount required for a previous page.

The available memory in RAM 28 is monitored (step 62c) and it is determined whether the available memory exceeds the critical value (step 62d). If the answer is no, the method continues with step 64a and the print job data for that page is stored to disk 26. If the answer is yes, the method continues with step 64c and the print job data for that page is stored in RAM 28.

Page N is processed and either stored to disk 26 or in RAM 28 based upon answers to the questions posed in steps 62a and 62d. Steps 64a and 64b are reached when either print job data for a prior page of the current print job was stored to disk (see step 62a) or the available memory in RAM 28 does not exceed a critical value (step 62d). In steps 64a and 64b, page N is processed and stored to disk 26. Processing involves rasterizing, compressing, and writing to RAM 28. Once written to RAM 28, the print job data for page N is transferred to disk 26. The memory holding page N in RAM 28 is released and can be used when processing a subsequent page.

Steps 64c-64g are reached when print job data for a prior page was successfully stored in RAM 28 (see step 62a) and the available memory in RAM 28 exceeds a critical value (step 62d). As page N is processed in step 64c, RAM 28 is monitored for a memory-out condition (step 64d). A memory-out condition occurs when the available memory in RAM 28 is depleted. This occurs when the memory required to store the actual print job data for page N exceeds the available memory in RAM 28 monitored in step 62c. So long as there is sufficient RAM, page N continues to be processed and is fully written and write-protected in RAM 28 (step 64e). Write protecting involves locking the portion of RAM 28 to which print job data for a page is written and not releasing that memory for other purposes until all copies of that page have been printed.

If there is not sufficient RAM, the method continues with step 64f where print job data for page N−1, the previous page stored in RAM 28, is sent to disk 26. The memory in RAM 28 used to store print job data for page N−1 is released (step 64g). The released memory can then be used to process page N, and the method repeats with step 62a. Because page N−1 has no longer been successfully stored in RAM 28, the answer to the question posed in step 62a will be no, and page N will be processed in RAM 28 (step 64a) and stored to disk 26 (step 64b). It is noted that there is still a risk that the memory required to process page N will exceed the memory available in RAM 28 and another memory-out condition will occur. In such an event, print data for previous pages (N−2, N−3, and so forth) is moved to disk 26 until enough memory is released to process page N in RAM 28.

Detecting a memory-out condition in step 64d is a reactive approach that causes the previous page and the current page to be stored on disk 26. In contrast, reaching a decision as to where to store print job data based upon questions posed in steps 62a and 62d represents a proactive approach. As shown in FIG. 10, the proactive approach is used first. In most cases, the critical value identified in step 62b will exceed the memory required to process the current page in RAM 28. Where it does not, a reactive approach is used to identify a memory-out condition so print job data can be moved to disk 26 releasing the necessary memory in RAM 28.

Some of the method steps are described as being performed by a particular component of an image forming device. It is noted that the method steps may be performed in other manners and by other components, shown or not. Although the flow charts of FIGS. 9 and 10 show a specific order of execution, the order of execution may differ from that which is depicted. For example, the order of execution of two or more blocks may be scrambled relative to the order shown. Also, two or more blocks shown in succession may be executed concurrently or with partial concurrence. All such variations are within the scope of the present invention.

The present invention has been shown and described with reference to the foregoing exemplary embodiments. It is to be understood, however, that other forms, details, and embodiments may be made without departing from the spirit and scope of the invention that is defined in the following claims.

What is claimed is:

1. A memory management method, comprising:
receiving data separable into segments;
for each segment:
determining whether to save that segment to a first memory or to a second memory;
saving that segment to a determined location; and
while saving each segment determined to be saved to the first memory:
determining whether the first memory is depleted; and
if the first memory is depleted, instead saving that segment to the second memory.

2. The method of claim 1, further comprising, while saving each segment determined to be saved to the first memory:
determining whether the first memory is depleted; and
if the first memory is not depleted, continuing to save that segment to the first memory.

3. The method of claim 1, further comprising moving a segment previously saved to the first memory to the second memory if the first memory is determined to be depleted.

4. The method of claim 1, wherein determining whether to save that segment to a first memory or to a second memory includes:
identifying a critical value;
monitoring available memory in the first memory;
determining to save that segment to the second memory if the critical value exceeds the monitored available memory in the first memory; and
determining to save that segment to the first memory if the critical value does not exceed the monitored available memory in the first memory.

5. The method of claim 4, wherein identifying a critical value comprises calculating an average value for the amount of memory required to save each of a previous number of segments to the first memory.

6. The method of claim 4, wherein identifying a critical value comprises calculating an average value for the amount of memory required to save each of a previous number of segments to the first memory and then increasing the average value.

7. The method of claim 4, wherein identifying a critical value comprises identifying the largest amount of memory required to save one of a group of previous segments.

8. The method of claim 4, wherein identifying a critical value comprises identifying the largest value of memory required to save one of a group of previous segments and decreasing the largest value.

9. The method of claim 4, wherein determining whether to save that segment to a first memory or to a second memory includes also includes determining to save that segment to the second memory if a prior segment has been saved to the second memory.

10. The method of claim 1, wherein determining whether to save that segment to a first memory or to a second memory includes determining to save that segment to the second memory if a prior segment has been saved to the second memory.

11. A method for storing print job data, comprising:
receiving a print job separable into segments;
for each segment:
determining whether to save print job data processed from that segment to a first memory or to a second memory;
processing that segment into print job data; and
saving the print job data to the determined location; and
while saving print job data determined to be saved in the first memory:
determining whether the first memory is depleted; and
if depleted, saving that print job data to the second memory.

12. The method of claim 11, further comprising, while saving print job data determined to be saved to the first memory:
determining whether the first memory is depleted; and
if the first memory is not depleted, continuing to save that segment to the first memory.

13. The method of claim 11, further comprising, moving print job data previously stored in the first memory to the second memory if the first memory is determined to be depleted.

14. The method of claim 11, wherein determining whether to save print job data processed from that segment to a first memory or to a second memory includes:
identifying a critical value;
monitoring available memory in the first memory;
determining to save print job data processed from that segment to the second memory if the critical value exceeds the monitored available memory in the first memory; and
determining to save print job data processed from that segment to the first memory if the critical value does not exceed the monitored available memory in the first memory.

15. The method of claim 14, wherein identifying a critical value comprises calculating an average value for the amount of memory required to save a segment processed into print job data.

16. The method of claim 14, wherein identifying a critical value comprises calculating an average value for the amount of memory required to save a segment processed into print job data and then increasing the average value.

17. The method of claim 14, wherein identifying a critical value comprises identifying, from a group of previously processed segments, the largest amount of memory required to save print job data.

18. The method of claim 14, wherein identifying a critical value comprises identifying, from a group of previously processed segments, the largest amount of memory required to save print job data, and decreasing the largest amount.

19. The method of claim 14, wherein determining whether to save print job data processed from that segment to a first memory or to a second memory also includes determining to save print job data processed from that segment to the second memory if a print job data processed from a prior segment has been saved to the second memory.

20. The method of claim 10, wherein determining whether to save print job data processed from that segment to a first memory or to a second memory includes determining to save print job data processed from that segment to the second memory if print job data processed from a prior segment has been saved to the second memory.

21. Machine readable media, having instructions for:
receiving data separable into segments;
for each segment:
determining whether to save that segment to a first memory or to a second memory;
saving that segment to a determined location; and
while saving each segment determined to be saved to the first memory:
determining whether the first memory is depleted; and
if the first memory is depleted, instead saving that segment to the second memory.

22. The media of claim 21, having further instructions for, while saving each segment determined to be saved to the first memory:
determining whether the first memory is depleted; and
if the first memory is not depleted, continuing to save that segment to the first memory.

23. The media of claim 21, having further instructions for moving a segment previously saved to the first memory to the second memory if the first memory is determined to be depleted.

24. The media of claim 21, wherein the instructions for proactively determining include instructions for:
identifying a critical value;
monitoring available memory in the first memory;
determining to save that segment to the second memory if the critical value exceeds the monitored available memory in the first memory; and
determining to save that segment to the first memory if the critical value does not exceed the monitored available memory in the first memory.

25. The media of claim 24, wherein the instructions for identifying a critical value include instructions for calculating an average value for the amount of memory required to save each of a previous number of segments to the first memory.

26. The media of claim 24, wherein the instructions for identifying a critical value include instructions for calculating an average value for the amount of memory required to save each of a previous number of segments to the first memory and then increasing the average value.

27. The media of claim 24, wherein the instructions for identifying a critical value include instructions for identifying the largest value of memory required to save one of a group of previous segments.

28. The media of claim 24, wherein the instructions for identifying a critical value include instructions for identifying the largest value of memory required to save one of a group of previous segments and decreasing the largest value.

29. The media of claim 24, wherein the instructions for determining whether to save that segment to a first memory or to a second memory also include instructions for determining to save that segment to the second memory if a prior segment has been saved to the second memory.

30. The media of claim 21, wherein the instructions for determining whether to save that segment to a first memory or to a second memory include instructions for determining to save that segment to the second memory if a prior segment has been saved to the second memory.

31. Machine readable media having instructions for:
receiving a print job separable into segments;
for each segment:
determining whether to save print job data processed from that segment to a first memory or to a second memory;
processing that segment into print job data; and
saving the print job data to the determined location; and
while saving print job data determined to be saved in the first memory:
determining whether the first memory is depleted; and
if depleted, saving that print job data to the second memory.

32. The media of claim 31, having further instructions for, while saving print job data determined to be saved to the first memory:
determining whether the first memory is depleted; and
if the first memory is not depleted, continuing to save that segment to the first memory.

33. The media of claim 31, having further instructions for moving print job data previously stored in the first memory to the second memory if the first memory is determined to be depleted.

34. The media of claim 31, wherein the instructions for proactively determining include instructions for:
identifying a critical value;
monitoring available memory in the first memory;
determining to save print job data processed from that segment to the second memory if the critical value exceeds the monitored available memory in the first memory; and
determining to save print job data processed from that segment to the first memory if the critical value does not exceed the monitored available memory in the first memory.

35. The media of claim 34, wherein the instructions for identifying a critical value comprise instructions for calculating an average value for the amount of memory required to save a segment processed into print job data.

36. The media of claim 34, wherein the instructions for identifying a critical value comprise instructions for calculating an average value for the amount of memory required to save a segment processed into print job data and then increasing the average value.

37. The media of claim 34, wherein the instructions for identifying a critical value comprise instructions for identifying, from a group of previously processed segments, the largest amount of memory required to save print job data.

38. The media of claim 34, wherein the instructions for identifying a critical value comprise instructions for identifying, from a group of previously processed segments, the largest amount of memory required to save print job data, and decreasing the largest amount.

39. The media of claim 34, wherein the instructions for determining whether to save print job data processed from that segment to a first memory or to a second memory also include instructions for determining to save print job data processed from that segment to the second memory if a print job data processed from a prior segment has been saved to the second memory.

40. The media of claim 31, wherein the instructions for determining whether to save print job data processed from that segment to a first memory or to a second memory include instructions for determining to save print job data processed from that segment to the second memory if print job data processed from a prior segment has been saved to the second memory.

41. A system, comprising:
a first memory;
a second memory; and
a guarantee module operable to:
receive data separable into segments;
determine whether to save a segment to the first memory or to the second memory;
save a segment to a determined location; and
while saving a segment to the first memory, determine
whether the first memory is depleted and, if depleted, instead save that segment to the second memory.

42. A system, comprising:
a first memory;
a second memory;
a rasterizer operable to render a print job into print job data;
a compressor operable to compress print job data; and
a controller operable to:
determine whether to save print job data to the first memory or to the second memory;
save print job data to a determined location; and
while saving print job data to the first memory, determine whether the first memory is depleted and, if depleted, instead save that print job data to the second memory.

43. The system of claim 42, wherein the controller is further operable to move print job data previously stored in the first memory to the second memory if the first memory is determined to be depleted.

44. The system of claim 42, wherein the controller is operable to proactively determine by:
identifying a critical value;
monitoring available memory in the first memory;
determining to save print job data to the second memory if the critical value exceeds the monitored available memory in the first memory; and
determining to save print job data to the first memory if the critical value does not exceed the monitored available memory in the first memory.

45. The system of claim 44, wherein the controller is further able to determine whether to save print job data to the first memory or to the second memory by determining to save print job data to the second memory if other print job data rendered from the same print job has been saved to the second memory.

46. The system of claim 42, wherein the controller is able to determine whether to save print job data to the first memory or to the second memory by determining to save print job data to the second memory if other print job data rendered from the same print job has been saved to the second memory.

47. A system, comprising:
a first memory;
a second memory; and
a means for receiving data separable into segments;
a means for determining whether to save a segment to the first memory or to the second memory;
a means for saving a segment to a determined location; and
a means for, while saving a segment to the first memory, determining whether the first memory is depleted and, if depleted, instead saving that segment to the second memory.
